(19) United States
(12) Patent Application Publication
(10) Pub. No.: US 2020/0062527 A1
(43) Pub. Date: Feb. 27, 2020

(54) CONVEYING APPARATUS

(71) Applicant: RISO KAGAKU CORPORATION, Tokyo (JP)

(72) Inventor: Kazuyuki AOKI, Ibaraki (JP)

(73) Assignee: RISO KAGAKU CORPORATION, Tokyo (JP)

(21) Appl. No.: 16/527,518

(22) Filed: Jul. 31, 2019

(30) Foreign Application Priority Data
Aug. 24, 2018 (JP) 2018-157081

(51) Int. Cl. B65H 23/14; B41J 15/16

(52) U.S. Cl. CPC B65H 23/14; B41J 15/16

(57) ABSTRACT

A conveying apparatus that carries in a web to he wound in a rolled state or unrolls and carries out the web wound in a rolled state includes a movable roller capable of moving in a vertical direction that is arranged between a carry-in port or a carry-out port of the web and the web wound in a rolled state to apply a tensile force to the web, and a movable-roller holding unit that releases the tensile force by a holding stand that holds the movable roller so as not to fall, at a time of replacement of the web.

### TECHNICAL FIELD

The present invention relates to a conveying apparatus that conveys a web as a belt-like medium.

### RELATED ART

A web is used when forms, for example, regular slips are printed in large amounts at one time. At this time, the web printed by a printing device is wound around a winding roll of a winding device. The web supplied to the printing device is supplied, for example, from a paper feed roll of a paper feeding device.

The discharge velocity of the printed web to be discharged from the printing device and the circumferential velocity of the web immediately after being wound around the winding roll of the winding device are different in many cases. The circumferential velocity of the winding roll after winding the web changes at all times depending on the diameter thereof.

In order to absorb a velocity difference between the discharge velocity of the web and the circumferential velocity of the web immediately after being wound around the winding roll of the winding device and to prevent the web from loosening, a movable roller capable of moving vertically by self-weight is provided in the winding device. A lower surface of the movable roller is supported by the web and when the discharge velocity on the printing device side is faster than the circumferential velocity of the web wound around the winding roll, the movable roller moves downward, and in an opposite case, moves upward.

The movable roller applies a tensile force to the web between the printing device and the winding device, suppresses an occurrence of loosening, and advances the web stably without causing wrinkles, folds, and paper jam. Since the movable roller is supported by the web, in a state before the web is set, the movable roller needs to be held at an upper limit of a vertical moving range thereof. That is, in a state without the web, the movable roller loses support. Therefore, the web falls to a lower limit position of the moving range.

An invention in which a movable roller is held at an upper limit position in order to prevent fall of the movable roller and facilitate the maintenance work of a web is disclosed in, for example, Japanese Patent Application Publication No. 2016-88640.

### SUMMARY

The invention disclosed in Japanese Patent Application Publication No. 2016-88640 is effective when a web is set initially. However, in an actual maintenance work, the web is replaced by a new web before the entire web is wound by a winding device in many cases. If the entire web has been wound, a work of inserting a new web into a printing device having a complicated conveying route is required. To avoid this work, it is general to replenish (connect) a new web to the previous web.

When a web is to be replenished, the tensile force due to the movable roller has been generated in the currently present web. Therefore, if the currently present web is cut, the movable roller loses support and falls. As a result, the web is largely pulled back.

Therefore, two or more workers, for example, a worker who holds the movable roller so that the web is not pulled back and a worker who connects the webs are required. Further, it is a difficult work to hold the movable roller at an upper limit position and connect a new web straight to the web in a state with the tensile force not being applied and without distortions. If a web is connected in a distorted state with respect to the conveying route, a certain amount of feeding operation needs to be performed until conveyance becomes stable, and thus unnecessary consumption of the web occurs. Further, time required for the maintenance work becomes more than necessary, in this manner, there is such a problem that the maintenance work is difficult in the conventional conveying apparatus that conveys a web.

The present invention has been made in view of such a conventional problem. An object of the present invention is to facilitate the maintenance work of a conveying apparatus that conveys a web.

In order to achieve the above object, a conveying apparatus according to the present invention carries in a web to be wound in a rolled state or unrolls and carries out the web wound in a rolled state, the conveying apparatus comprising: a movable roller capable of moving in a vertical direction that is arranged between a carry-in port or a carry-out port of the web and the web wound in a rolled state to apply a tensile force to the web; and a movable-roller holding unit that releases the tensile force by a holding stand that holds the movable roller so as not to fall, at a time of replacement of the web.

According to the conveying apparatus of the present invention, it is possible to facilitate the maintenance work.

### BRIEF DESCRIPTION OF DRAWINGS

The invention will now be described with reference to the accompanying drawings wherein:

FIG. 1 is a diagram schematically illustrating a configuration example of a printing system that uses a conveying apparatus according to an embodiment of the present invention; example of the conveying apparatus according to the embodiment of the present invention;

FIG. 3A is a diagram illustrating a case where a movable-roller holding unit of the conveying apparatus illustrated in FIG. 2 is in an upper-limit position mode;

FIG. 3B is a diagram illustrating a case where the movable-roller holding unit of the conveying apparatus illustrated in FIG. 2 is in a holding mode;

FIG. 3C is a diagram illustrating a case where the movable-roller holding unit of the conveying apparatus illustrated in FIG. 2 is in a conveying mode;

FIG. 4 is a diagram schematically illustrating a configuration example of a part of the movable-roller holding unit of the conveying apparatus as viewed in a conveying direction of a web; and

FIG. 5 is a flowchart illustrating a process procedure of a control unit illustrated in FIG. 2.

### DETAILED DESCRIPTION

Embodiments of the present invention will be described below with reference to the drawings. In the drawings, like or equivalent parts or constituent elements are denoted by like or equivalent reference signs and explanations thereof are omitted or simplified.

### (Printing System)

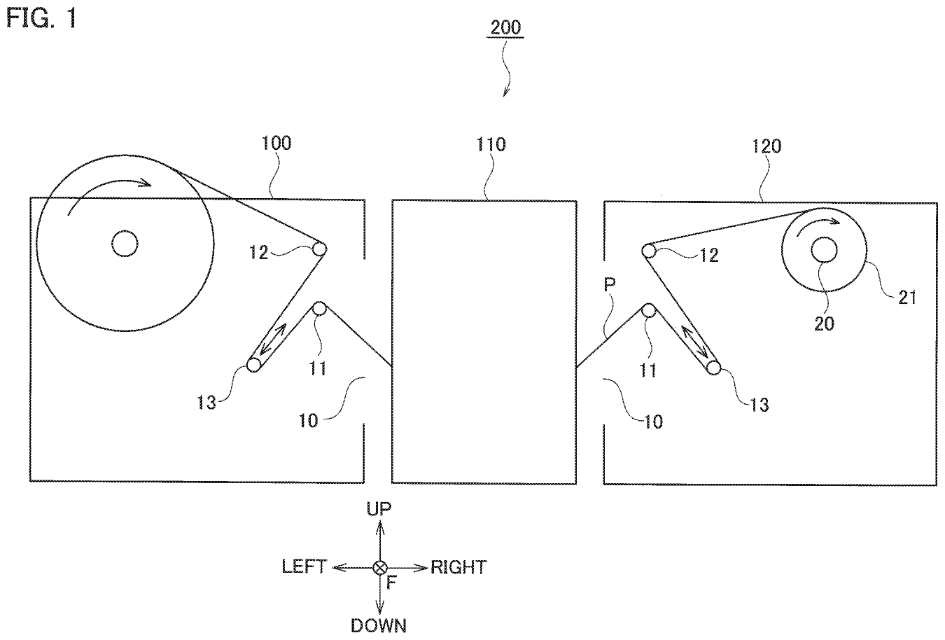

FIG. 1 is a diagram schematically illustrating a configuration example of a printing system that uses a conveying apparatus according to an embodiment of the present invention. A printing system 200 illustrated in FIG. 1 is configured by a paper feeding device 100, a printing device 110, and a winding device 120. The paper feeding device 100 and the winding device 120 correspond to the conveying apparatus according to the present embodiment. The printing device 110 is a general printing device, for example, an ink-jet printing device.

The paper feeding device 100 feeds a web to the printing device 110 by unrolling the web wound in a rolled state. Further, the winding device 120 winds the web discharged from the printing device 110 in a rolled state. The paper feeding device 100 and the winding device 120 are the same apparatus, although there is a difference therebetween, such that one device unrolls the web and carries out the web and the other carries in the web and winds the web. In FIG. 1, the left side is an upstream side of a printing process performed by the printing system 200 and the right side is a downstream side thereof. In FIG. 1, it is defined that a direction orthogonal to a right and left direction is an up and down direction, a far side is front (F), and a near side is rear (R).

The conveying apparatus 120 that winds a printing medium is described below as an example of the conveying apparatus according to the present embodiment. Further, for example, a continuous form paper P is described as an example of the web,

The conveying apparatus 120 illustrated in FIG. 1 includes a carry-in port 10, a pair of guide rollers 11 and 12, a movable roller 13, a paper core 20, and a winding roll 21. FIG. 1 illustrates only a main conveying route of the continuous form paper P, and illustrations of other configurations are omitted. The movable roller 13 is generally referred to as “dancer roller”.

The pair of guide rollers 11 and 12 guide the continuous form paper P conveyed from the carry-in port 10 to the winding roll 21 wound around the paper core 20. The movable roller 13 presses down the continuous form paper P between the guide rollers 11 and 12 in a direction of gravity by self-weight to apply a tensile force to the continuous form paper P. The tensile force suppresses wrinkles generated in the continuous form paper P and prevents an occurrence of uneven winding of the winding roll 21.

The conveying apparatus 100 is different from the conveying apparatus 120 in that it feeds the continuous form paper P to the printing device 110. An example illustrated in FIG. 1 is a diagram illustrating a first half of the printing process performed by the printing system 200, and a diameter of the feed roll of the conveying apparatus 100 is larger than that of the winding roll 21 of the conveying apparatus 120.

### (Conveying Apparatus)

### (Configuration)

FIG. 2 is a diagram schematically illustrating a more specific functional configuration example of the conveying apparatus 120. The conveying apparatus 120 includes a brake unit 14, a movable-roller holding unit 15, a deceleration mechanism 16, a winding motor 17, and a control unit 18 in addition to the configuration illustrated in FIG. 1.

As illustrated in FIG. 2, the continuous form paper P carried in from the carry-in port 10 is guided to the winding roll 21, while sequentially abutting on an upper surface of the guide roller 11 on the upstream side, a lower surface of the movable roller 13, and an upper surface of the guide roller 12 on the downstream side. A point indicated by “×” near the carry-in port 10 represents an example of a connection point at which the continuous form paper P is replenished. The point indicated by “33” will be described later in detail.

The movable roller 13 is located below the guide roller 11 on the upstream side, and is supported rotatably by a carriage 13a that moves on a guide shaft G. The guide shaft G extends in a direction inclined by a predetermined angle with respect to the direction of gravity. By inclining an extending direction of the guide shaft G with respect to the direction of gravity, a moving distance of the movable roller 13 in the direction of gravity is reduced, thereby enabling to decrease the vertical size of the conveying apparatus 120.

The length of the guide shaft G in this case is longer than the length of the moving range of the movable roller 13 while conveying the continuous form paper P. The “moving range” of the movable roller 13 refers to a range in which the movable roller 13 moves in a vertical direction when the control unit 18 controls the rotational velocity of the winding motor 17. The control unit 18 will be described later in detail.

The guide shaft G can be extended in the direction of gravity. The guide rollers 11 and 12 in this case are arranged at the same height in the right and left direction. The guide shaft G is provided between the guide rollers 11 and 12 arranged at the same height.

The movable-roller holding unit 15 is provided so as to be along the right side of the guide shaft G. The movable-roller holding unit 15 includes a holding-stand drive motor 15a, a drive pulley 15b, a tail pulley 15c, a belt 15d, and a holding stand 15e.

The holding stand 15e is fixed to a part of the belt 15d, and can move along the guide shaft G with the movement of the belt 15d. FIG. 2 illustrates an example in which the holding stand 15e is arranged at a lower limit position of the guide shaft G.

The brake unit 14 is arranged between the guide roller 12 on the downstream side and the winding roll 21. The brake unit 14 includes a pair of guide rollers 14a and 14b, and a brake roller 14c, around which the continuous form paper P between the both guide rollers 14a and 14b is wound.

The winding roll 21 formed by being wound around the paper core 20 is driven by the winding motor 17 via the deceleration mechanism 16. The winding motor 17 is controlled by the control unit 18.

### (Effect)

The movable roller 13 can move on the guide shaft G. The movable roller 13 applies a tensile force to the continuous form paper P spanned over the upper surface of the guide roller 11 on the upstream side, the lower surface of the movable roller 13, and the upper surface of the guide roller 12 on the downstream side by the self-weight of the movable roller 13.

When the circumferential velocity of the winding roll 21 immediately after winding the continuous form paper P is faster than the carry-in velocity of the continuous form paper P from the carry-in port 10, the movable roller 13 moves upward on the guide shaft G. On the other hand, when the circumferential velocity of the winding roll 21 immediately after winding the continuous form paper P is slower than the carry-in velocity of the continuous form paper P, the movable roller 13 moves downward on the guide shaft G.

That is, the movable roller 13 is arranged between the carry-in port 10 of the continuous form paper P and the winding roll 21 to absorb a velocity difference between the carry-in velocity of the continuous form paper P and the circumferential velocity of the winding roll 21 immediately after winding the continuous form paper P and generates a tensile force on the continuous form paper while being conveyed, and can move in a vertical direction.

The control unit 18 controls the circumferential velocity of the winding roll 21 based on the position of the movable roller 13 on the guide shaft G. That is, the control unit 18 controls the winding motor 17 so as to increase the circumferential velocity of the winding roll 21 when a vertical position of the movable roller 13 moves downward from a middle position. Further, the control unit 18 controls the winding motor 17 so as to decrease the circumferential velocity of the winding roll 21 when the vertical position of the movable roller 13 moves upward from the middle position. By being controlled in this manner, the movable roller 13 is located within the vertical moving range thereof to apply a tensile force continuously to the continuous form paper P by self-weight.

The holding stand 15e illustrated in FIG. 2 moves upward along the guide shaft G by rotating the holding-stand drive motor 15a in a normal direction. When the holding stand 15e moves upward, the holding stand 15e abuts on the carriage 13a that rotatably supports the movable roller 13. When the holding stand 15e is moved in the state abutting on the carriage 13a, the carriage 13a can be moved up to an upper limit position of the guide shaft G. The upper limit position of the guide shaft G is a position higher than the moving range of the movable roller 13 while conveying the continuous form paper P.

Further, the holding stand 15e can be moved downward along the guide shaft G by rotating the holding-stand drive motor 15a in a reverse direction. In this manner, the holding stand 15e can be moved vertically by the movable-roller holding unit 15.

By causing the holding stand 15e to abut on the carriage 13a, the tensile force applied to the continuous form paper P by the self-weight of the movable roller 13 can be released. That is, the continuous form paper P can be held as it is by supporting the movable roller 13 by the holding stand 15e.

The brake unit 14 brakes the continuous form paper P to apply a tensile force to the continuous form paper P between the guide roller 12 on the downstream side and the winding roll 21. As the brake roller 14c, for example, a power brake that generates a braking force by an electromagnetic clutch using magnetic iron powder can be used. The brake unit 14 is provided to stabilize conveyance of the continuous form paper P and is not an essential configuration.

A case where the conveying apparatus 120 is applied to the winding device of the continuous form paper P has been described as an example. However, as described above, the conveying apparatus 120 can be applied directly to the paper feeding device. When the conveying apparatus 120 is applied to the paper feeding device, the carry-in port 10 described above becomes a carry-out port, and the winding roll 21 becomes a paper feed roll. Only the conveying direction of the continuous form paper P is reversed, and the configuration of the conveying apparatus is the same.

As described above, the conveying apparatus 120 according to the present embodiment is a conveying apparatus that carries in the continuous form paper P in order to wind the continuous form paper P in a rolled state, or unrolls the continuous form paper P wound in a rolled state and carries out the continuous form paper P. The conveying apparatus 120 is arranged between the carry-in port or the carry-out port of the continuous form paper P and the continuous form paper P wound in a rolled state, and includes the movable roller 13 that can move vertically and applies a tensile force to the continuous form paper P, and the movable-roller holding unit 15 that releases the tensile force by the holding stand 15e that holds the movable roller 13 so as not to fall at the time of replacing the continuous form paper P. Accordingly, the maintenance work of the conveying apparatus that conveys a printing medium such as a continuous form paper can be facilitated.

Subsequently, the conveying apparatus 120 is described in more detail with reference to the drawings.

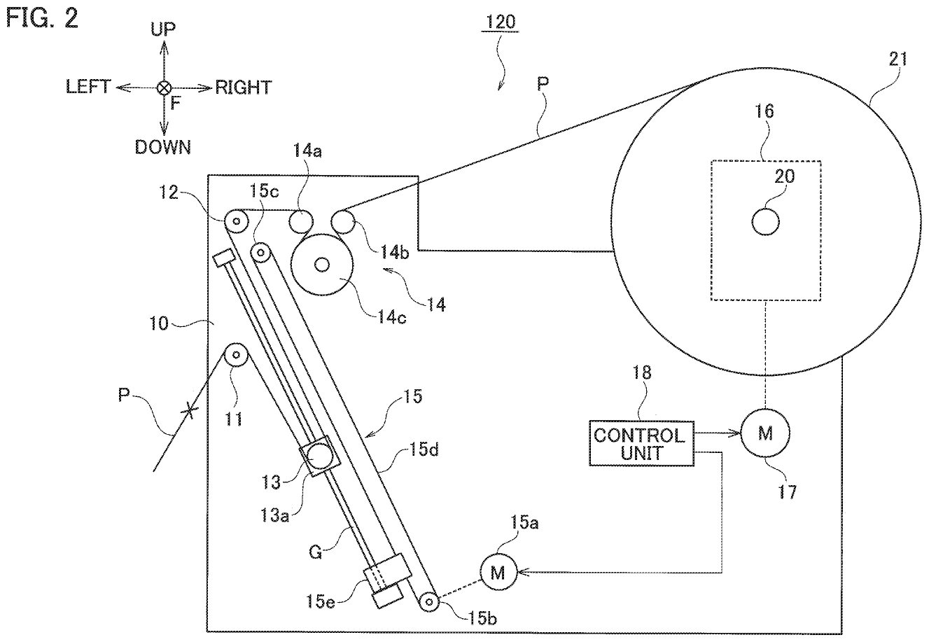

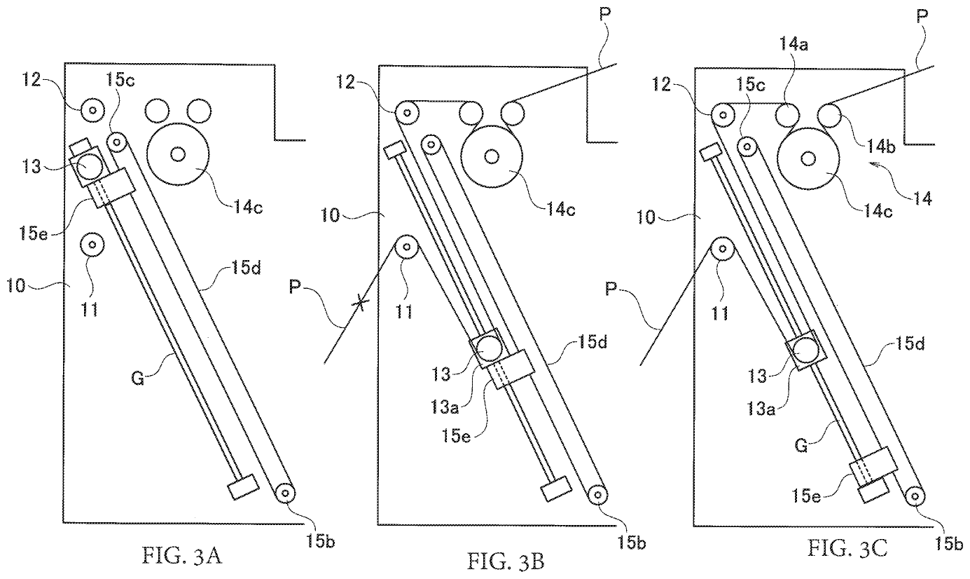

FIG. 3A, FIG. 3B, and FIG. 3C are diagrams schematically illustrating three states of the holding stand 15e. FIG. 3A illustrates the holding stand 15e that holds the movable roller 13 at a position higher than the moving range of the movable roller 13 while conveying the continuous form paper P. This state of the holding stand 15e is hereinafter referred to as “upper-limit position mode”.

FIG. 3B illustrates the holding stand 15e that holds the movable roller 13 at any position in the moving range of the movable roller 13 while conveying the continuous form paper P. This state of the holding stand 15e is hereinafter referred to as “holding mode”.

FIG. 3C illustrates a state in which the holding stand 15e is arranged at a lower limit position of the guide shaft G. This state of the holding stand 15e is hereinafter referred to as “conveying mode”.

In this manner, the conveying apparatus 120 according to the present embodiment has three modes of the upper-limit position mode, the holding mode, and the conveying mode. The respective modes are described below in detail.

### (Upper-Limit Position Mode)

The upper-limit position mode (FIG. 3A) is a mode in which when the continuous form paper P is to be set in the conveying apparatus 120, the movable roller 13 is arranged by the holding stand 15e at a position higher than the upper limit of the moving* range of the movable roller 13 while conveying the continuous form paper P. Control of this mode is executed by the control unit 18. This is also true for other modes. The control unit 18 will be described later in detail.

In the upper-limit position mode, the movable roller 13 is pushed up by the holding stand 15e together with the carriage 13a and arranged at the upper limit position of the guide shaft G. The movable roller 13 at this position can be visually seen from the carry-in port 10. Therefore, a worker can easily insert the continuous form paper P to between the movable roller 13 and the carriage 13a and span the continuous form paper P over the guide roller 12 on the downstream side.

In the upper-limit position mode, the movable roller 13 is held by the holding stand 15e. Therefore, the continuous foam paper P can be easily set by one worker.

### (Holding Mode)

The holding mode (FIG. 3B) is a mode in which the movable roller 13 is held by the holding stand 15e, when a new continuous form paper P is to be set in a state in which the continuous form paper P still remains. The position of the movable roller 13 in this case is at any position in the moving range of the movable roller 13 while conveying the continuous form paper P.

In FIG. 3B, a case where old continuous form paper P is cut at a point indicated by “×”, and new continuous form paper P is replenished to the cut portion is assumed. The control unit 18 in this case causes the holding stand 15e to move so as to hold the movable roller 13 at this position. This position refers to any position in the moving range of the movable roller 13, which is determined by a relation between the carry-in velocity and the circumferential velocity of the winding roll 21 while the continuous form paper P is being conveyed.

In the holding mode, since the movable roller 13 is supported by the holding stand 15e, the tensile force applied to the continuous form paper P by the self-weight of the movable roller 13 can be released. As a result, the point indicated by “×” at which the continuous form paper P has been cut is maintained as it is. Therefore, the continuous form paper P is not pulled back, and the new continuous form paper P can be connected thereto straight in a front (F)—rear (R) direction without distortions.

That is, the control unit 18 includes the upper-limit position mode in which the movable roller is arranged by the holding stand 15e at a position higher than the upper limit of the moving range of the movable roller 13 while conveying the continuous form paper P, and the holding mode in which the continuous form paper P is held at any position in the moving range of the movable roller 13 by the holding stand 15ewhile conveying the continuous form paper P. Accordingly, in the upper-limit position mode, since the movable roller 13 is arranged at the upper-limit position at which an operation is easily performed, the continuous form paper P can be easily set. Further, in the holding mode, since the movable roller 13 is held by the holding stand 15e, the continuous form paper P is not pulled back by the self-weight of the movable roller 13. The maintenance work of the continuous form paper P can be facilitated in this manner.

### (Conveying Mode)

The conveying mode (FIG. 3C) is a mode in which the holding stand 15e is arranged at the lower limit position of the guide shaft when the continuous form paper P is being conveyed. The movable roller 13 in this case moves sequentially to any position in the moving range that is determined by a relation between the carry-in velocity of the continuous form paper P and the circumferential velocity of the winding roll 21. The holding stand 15e in this case is arranged at a position lower than the moving range of the movable roller 13 while conveying the continuous form paper P. That is, the holding stand 15e does not interrupt the movement of the movable roller 13 while conveying the continuous form paper P.

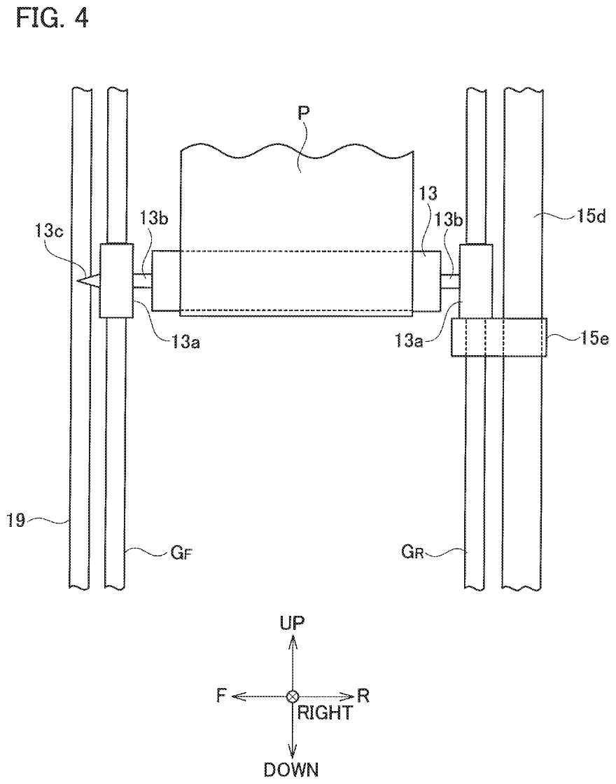

FIG. 4 is a diagram schematically illustrating a configuration example of the movable roller 13 as viewed in the conveying direction of the continuous form paper P, and is an example of illustrating the positions of the holding stand 15e and the movable roller 13 in the holding mode.

The movable roller 13 is rotatably supported by two carriages 13a via a rotation shaft 13b. Each of the two carriages 13a can move on guide shafts G_{F} and G_{R}. A linear sensor 19 that detects the position of the movable roller 13 is arranged along the guide shaft G_{F}.

The position of the movable roller 13 on the guide shafts G_{F} and G_{R} is detected by detecting a position of an apex of a pointer 13c extended from the rotation shaft 13b by the linear sensor 19. For example, the vertical position of the movable roller 13 can be detected by the linear sensor 19 in which a plurality of Hall elements (not illustrated) are arranged linearly by magnetizing the pointer 13c. The detection of the position can be performed, for example, with an accuracy of 0.1 millimeter or more.

The vertical position of the movable roller 13 can be detected based on a change of electrostatic capacitance or can be detected optically.

### (Control Unit)

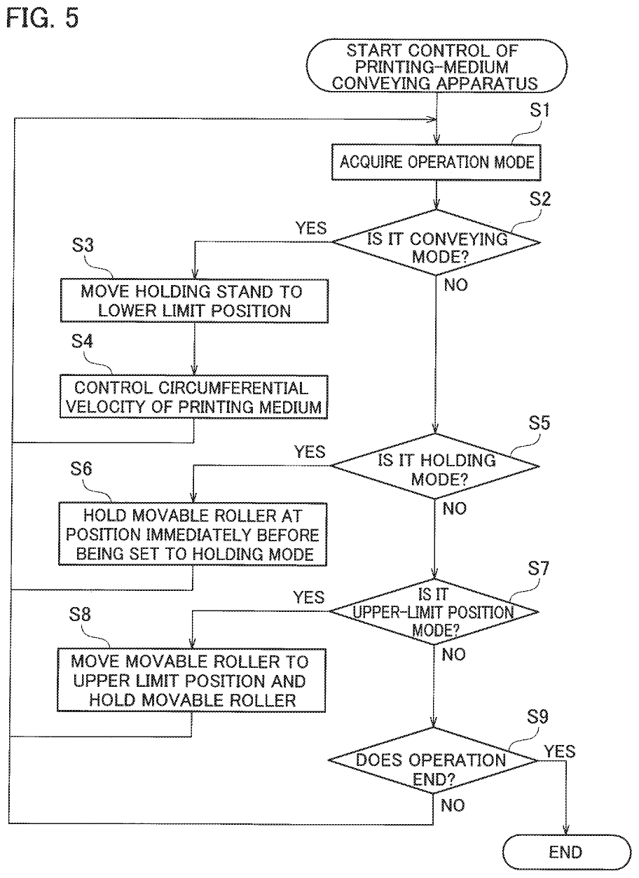

FIG. 5 is a flowchart illustrating a process procedure of the control unit 18. The control unit 18 is realized by a computer (a controller) constituted by, for example, a ROM, a RAM, or a CPU.

When the conveying apparatus 120 starts operation, the control unit 18 acquires an operation mode of the conveying apparatus 120 (Step S1). The operation mode is the conveying mode, the holding mode, and the upper-limit position mode described above. These operation modes are represented by a 2-hit digital value and stored in, for example, the RAM described above. The operation mode is set by operating an operation panel (not illustrated) by a user (a worker).

When the acquired operation mode is the conveying mode (YES at Step S2), the control unit 18 causes the holding stand 15e to move to the lower limit position of the guide shaft G, which is lower than the moving range described above of the movable roller 13 (Step S3). The control unit 18 then compares the vertical position of the movable roller 13 detected by the linear sensor 19 with a reference position thereof to control the rotational velocity of the winding motor 17 (Step S4). The reference position is, for example, a central position of the moving range of the movable roller 13 while conveying the continuous form paper P.

When it is assumed that the moving range of the movable roller 13 is, for example, 100 centimeters, and the resolution of position detection in the vertical direction is, for example, 0.1 millimeter, the moving range can be represented by a 10-bit digital value (0 to 1023). In this case, the control unit 18 controls the rotational velocity of the winding motor 17 based on a result of comparison between the reference value (511) and a digital value detected by the linear sensor 19.

When the vertical position of the movable roller 13 detected by the linear sensor 19 is (500), the control unit 18 increases the rotational velocity of the winding motor 17. Further, when the vertical position of the movable roller 13 is (520), the control unit 18 decreases the rotational velocity of the winding motor 17.

By executing control in this manner, the position of the movable roller 13 while conveying the continuous form paper P can be controlled so as to be in the middle of the moving range thereof.

The control unit 18 executes control in such a manner that the movable roller 13 is held in the upper-limit position mode at the time of feeding the continuous form paper P, and the movable roller 13 is held in the holding mode at the time of re-connection of the continuous form paper P. Feeding refers to setting the continuous form paper P initially. Re-connection refers to replenishing (re-connecting) new continuous form paper P to the continuous form paper P before the entire continuous form paper P is wound.

Accordingly, when the continuous form paper P is to be newly fed, the movable roller 13 is arranged at a position easily accessible from the carry-in port 10, thereby enabling to facilitate the feeding. Further, when the continuous form paper P is to be replenished, the movable roller 13 is held by the holding stand 15e at a position lastly positioned in the moving range of the movable roller 13. Therefore, the tensile force applied to the continuous form paper P by the self-weight of the movable roller 13 is released. As a result, the continuous form paper P is not pulled back, and the new continuous form paper P can be connected straight without distortions.

Further, the control unit 18 in the conveying mode arranges the holding stand 15e at a position lower than the lower limit of the moving range of the movable roller 13 while the continuous form paper P is being conveyed. Accordingly, the holding stand 15e can be automatically evacuated at the time of conveying the continuous form paper P. Since the holding stand 15e does not affect the conveying operation of the continuous form paper P, a worker does not need to be conscious about the movable roller 13.

When the acquired operation mode is the holding mode (YES at Step S5), the control unit 18 causes the holding stand 15e to move to a position at which the position of the movable roller 13 immediately before the operation mode transits to the holding mode is maintained. As a result, the movable roller 13 is held by the holding stand 15e, and the tensile force applied to the continuous form paper P by the self-weight of the movable roller 13 is released (Step S6).

The position of the movable roller 13 immediately before the operation mode transits to the holding mode can be ascertained by sequentially storing detection signals of the linear sensor 19. The detection signal of the linear sensor 19 is stored, for example, in the RAM described above. When the operation mode transits to the holding mode, the control unit 18 immediately reads the detection signal of the linear sensor 19 stored in the RAM, and controls the holding-stand drive motor 15a so as to move the holding stand 15e to a position corresponding to the detection signal.

It can be detected whether the holding stand 15e has reached the position of the movable roller 13 immediately before the operation mode transits to the holding mode, by detecting that the detection signal of the linear sensor 19 has changed in an upward direction. That is, when it is assumed that the detection signal of the linear sensor 19 stored in the RAM is (550), the holding stand 15e has reached the position when the detection signal of the linear sensor 19 has changed to (551).

Thereafter, by controlling the holding-stand drive motor 15a in such a manner that the detection signal of the linear sensor 19 becomes (550), the holding stand 15e can be held at the position of the movable roller 13 immediately before the operation mode transits to the holding mode.

In this manner, in the holding mode, the holding stand 15e is fixed to a position where the tensile force applied to the continuous form paper P by the self-weight of the movable roller 13 is released, based on the detection signal of the linear sensor 19 that detects the vertical position of the movable roller 13. Accordingly, a sensor for position control of the holding stand 15e can serve also as a sensor for position control of the movable roller 13, thereby enabling to reduce the number of components.

The holding stand 15e can be held by another method. The holding stand 15e can be locked by a lock pin so that the holding stand 15e does not descend due to the self-weight of the movable roller 13, or a brake can be provided so that the belt 15d that moves the holding stand 15e does not move. A general lock pin and brake can be used therefor.

When the acquired operation mode is the upper-limit position mode (YES at Step S7), the control unit 18 arranges the movable roller 13 to a position higher than the upper limit of the moving range of the movable roller 13 by the holding stand 15e (Step S8). The movable roller 13 in the upper-limit position mode can be visually seen from the carry-in port 10. Therefore, a worker can easily set the continuous form paper P in the conveying apparatus 120.

When the operation of the conveying apparatus 120 is stopped, the control unit 18 ends the operation (YES at Step S9). When the operation is to be continued, processes at Steps S1 to S8 are repeated (NO at Step S9).

As described above, according to the conveying apparatus 120, a maintenance work such as replacement of a continuous form paper P can be facilitated. In the above embodiment, an example of a winding device that winds the continuous form paper P has been described. However, the technical idea illustrated in the present embodiment can be directly applied to a paper feeding device.

In the case of the paper feeding device, the carry-in port 10 becomes a carry-out port, and the winding roll 21 becomes a paper feed roll. Further, the carry-in velocity described above becomes a carry-out velocity.

Further, an example in which the moving direction of the movable roller 13 has an inclination angle with respect to the direction of gravity has been described in the above embodiment; however, the moving direction is not limited thereto. The moving direction of the movable roller 13 can be the direction of gravity. Further, the continuous form paper P has been described as an example of the web; however, the web can be a film or the like.

### <Others:>

The present invention is not limited exactly to the above embodiment, and when the invention is actually implemented, it may be embodied in other specific forms while modifying the constituent elements without departing from the spirit of the invention. In addition, various inventions may be formed by appropriate combinations of a plurality of constituent elements disclosed in the above embodiment. For example, several constituent elements may be omitted from all the constituent elements described in the above embodiment.

Further, for example, respective functions and processes described above may be implemented on one or more processing circuits. The processing circuits include programmed processors, electric circuits, and the like, and also include devices such as application specific integrated circuits (ASIC) and circuit constituent elements that are arranged to execute the functions described above.

This application claims priority based on Japanese Patent Application No. 2018-157081 filed on Aug. 24, 2018, and the entire content of this is incorporated herein by reference.

What is claimed is:

1. A conveying apparatus that carries in a web to be wound in a rolled state or unrolls and carries out the web wound in a rolled state, the conveying apparatus comprising:
a movable roller capable of moving in a vertical direction that is arranged between a carry-in port or a carry-out port of the web and the web wound in a rolled state to apply a tensile force to the web; and
a movable-roller holding unit that releases the tensile force by a holding stand that holds the movable roller so as not to fall, at a time of replacement of the web.

2. The conveying apparatus according to claim 1,
further comprising a control unit that controls the movable-roller holding unit, wherein
the control unit includes
an upper-limit position mode in which the movable roller is arranged by the holding stand at a position higher than an upper limit of a moving range of the movable roller while conveying the web, and
a holding mode in which the movable roller is held at any position in the moving range by the holding stand,

3. The conveying apparatus according to claim 2, wherein
the control unit executes control in such a manner that
the movable roller is held in the upper-limit position mode at a time of feeding the web, and
the movable roller is held in the holding mode at a time of re-connection of the web.

4. The conveying apparatus according to claim 2, wherein
the control unit includes a conveying mode in which the holding stand is arranged at a position lower than a lower limit of the moving range of the movable roller, while the web is being conveyed.

5. The conveying apparatus according to claim 2, wherein
in the holding mode, the holding stand is fixed at a position at which the tensile force is released based on a detection signal of a position sensor that detects a vertical position of the movable roller.
